(19) United States
(12) Patent Application Publication
(10) Pub. No.: US 2011/0077056 A1
(43) Pub. Date: Mar. 31, 2011

(54) METHOD AND APPARATUS FOR CONTROLLING OF BLUETOOTH HEADSET

(75) Inventors: Eui Soon PARK, Gyeonggi-do (KR); Deok Seong KIM, Gyeonggi-do (KR)

(73) Assignee: SAMSUNG ELECTRONICS CO., LTD., Gyeonggi-Do (KR)

(21) Appl. No.: 12/862,982

(22) Filed: Aug. 25, 2010

(30) Foreign Application Priority Data
Sep. 25, 2009 (KR) 10-2009-0091210

(51) Int. Cl. H04W 88/02

(52) U.S. Cl. 455/569.1

(57) ABSTRACT

A method of and an apparatus for controlling power of a headset operating via a protocol such as Bluetooth headset reduces power consumption. The Bluetooth headset has a power-off mode, a power-on mode, and a sensor mode. When the Bluetooth headset is set to the sensor mode, at least one sensor senses status information of the Bluetooth headset (whether the Bluetooth headset is being worn) and the Bluetooth headset may be turned on/off according to the sensed result.

### CLAIM OF PRIORITY

This application claims the benefit under 35 U.S.C. §119(a) from a Korean patent application filed in the Korean Intellectual Property Office on Sep. 25, 2009 and assigned Serial No. 10-2009-0091210, the entire disclosure of which is hereby incorporated by reference.

### BACKGROUND OF THE INVENTION

1. Field of the Invention

The present invention relates generally to wireless headsets that preferably is applicable to a Bluetooth headset. More particularly, the present invention relates to a method and an apparatus for automatically turning on/off a Bluetooth headset using a sensor.

2. Description of the Related Art

With the rapid development of technologies for electronic communications, such as the increase in electronic devices for supporting near wireless communications having relatively short communication range and considering mobility, such as Bluetooth, Zigbee, and Ultra-wideband (UWB), mobile terminals supporting Bluetooth function are also increasing. For example, a user accesses the Bluetooth function to establish a wireless communication channel between a Bluetooth headset and a mobile terminal so that the user can perform a call and enjoy music without holding the mobile terminal within a preset range of each other.

Meanwhile, in order to use the Bluetooth function, the Bluetooth headset must be always turned on. However, it is inefficient to always keep the Bluetooth headset turned on due to excessive consumption of a battery. For example, when a user keeps the Bluetooth headset turned on for a long time, the battery is discharged and the Bluetooth headset may not be usable due to the reduced battery capacity when the user actually desires to utilize the Bluetooth headset. That is, according to a conventional Bluetooth headset, when the Bluetooth headset is not used, the user must turn the Bluetooth headset off manually to prevent the battery being consumed.

### SUMMARY OF THE INVENTION

The present invention provides a method and an apparatus for automatically turning a Bluetooth headset on/off using a sensor.

The present invention also provides a method and an apparatus for sensing state information of a Bluetooth headset, that is, the state as to whether the Bluetooth headset is worn, by using a plurality of sensors so that erroneous sensing on whether the Bluetooth headset is worn may be reduced.

In accordance with an exemplary embodiment of the present invention, there is provided a method of controlling power of a Bluetooth headset that preferably includes: setting a mode of the Bluetooth headset to a sensor mode; sensing whether or not the Bluetooth headset is worn; and automatically turning the Bluetooth headset on/off according to the sensing.

In accordance with another exemplary embodiment of the present invention, there is provided an apparatus for controlling power of a Bluetooth headset that preferably includes: a sensor unit including at least one sensor for sensing whether the Bluetooth headset is worn; and a controller controlling power on/off of the Bluetooth headset according to an output signal from the sensor unit corresponding to whether the Bluetooth headset is worn.

### BRIEF DESCRIPTION OF THE DRAWINGS

The above and other exemplary aspects, features, and advantages of certain exemplary embodiments of the present invention will become more apparent from the following description taken in conjunction with the accompanying drawings, in which:

FIG. 1 is a block diagram schematically illustrating configuration of a Bluetooth headset according to an exemplary embodiment of the present invention; and

FIG. 2 is a flowchart illustrating a power controlling method of a Bluetooth headset according to an exemplary embodiment of the present invention.

### DETAILED DESCRIPTION

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring appreciation of the subject matter of the present invention by a person of ordinary skill in the art.

Particular terms may be defined to describe the invention in the best manner that is understood by a person of ordinary skill in the art. Accordingly, the meaning of specific terms or words used in the specification and the claims should not be limited to the literal or commonly employed sense, but should be construed in accordance with the spirit of the invention. The description of the various exemplary embodiments is to be construed as illustrative only and does not describe every possible instance of the invention not limit the appended claims to such examples. Therefore, it should be understood by a person of ordinary skill in the art that various changes may be made and equivalents may be substituted for elements of the invention.

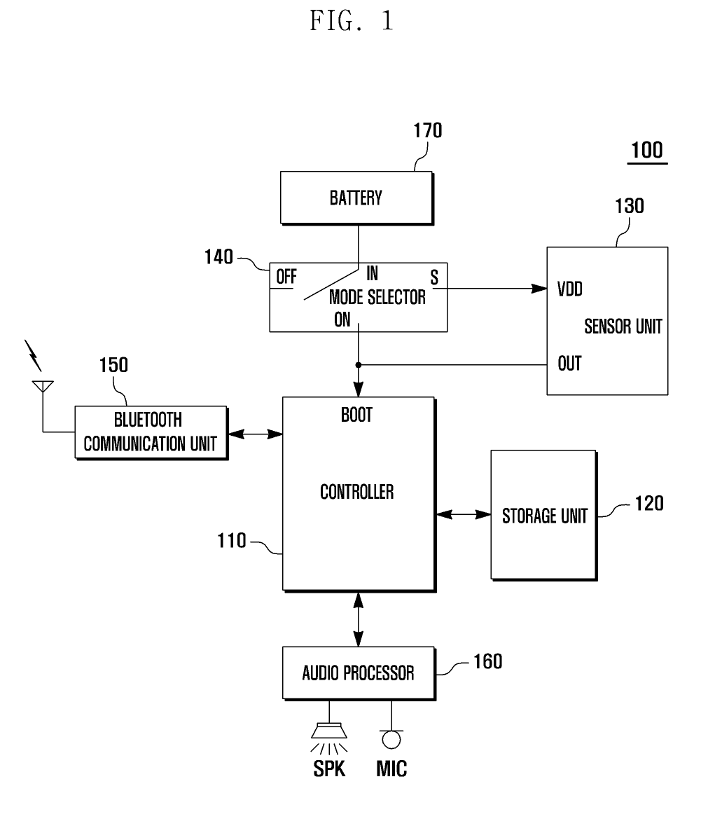

FIG. 1 is a block diagram schematically illustrating configuration of a Bluetooth headset according to an exemplary embodiment of the present invention.

Referring to now FIG. 1, a Bluetooth headset 100 may include, for example, a Bluetooth communication unit 150, a controller 110, a storage unit 120, a sensor unit 130, a mode selector 140, a battery 170, and an audio processor 160. When a sensor mode is selected by the mode selector 140 which may select a power-on mode, a power-off mode, and a sensor mode, the Bluetooth headset 100 senses state information of the Bluetooth headset 100 through at least one sensor such as a temperature sensor, an optical sensor, a touch sensor, and a tilt sensor and automatically turns the Bluetooth headset 100 on/off according to an output signal from the sensor unit 130 corresponding to the state information. Hereinafter, the respective elements of the Bluetooth headset 100 will be described in more detail.

The audio processor 160 may convert a digital audio signal received by the Bluetooth communication unit 150 of the Bluetooth headset 100 via controller 110 into an analog audio signal and transmit the converted signal to a speaker SPK, and alternatively may convert an analog audio signal input from a microphone MIC into a digital audio signal and transmit the converted signal to the controller 110. For example, when a voice call is performed using the Bluetooth communication function, the audio processor 160 may transmit an audio signal received from a specific terminal such as a user mobile terminal in which the Bluetooth communication is enabled to the speaker SPK. The audio processor 160 may also transmit a voice signal received from the microphone MIC to the controller 110 and the specific terminal through the Bluetooth communication unit 150. The audio processor 160 may receive an audio signal corresponding to a music file which the specific terminal is reproducing under the control of the controller 110 through the Bluetooth communication unit 150 and may transmit the audio signal to the speaker SPK.

With continued reference to FIG. 1, the battery 170 may supply electric power required to drive the Bluetooth headset 100. When a power-off mode is selected by the mode selector 140, the battery 170 may be an open state where the power is cut off. When a power-on mode is selected by the mode selector 140, the battery 170 may be connected to a booting terminal BOOT of the controller 110 to supply a booting signal to the controller 110 and may supply power to respective elements of the Bluetooth headset 100.

When the sensor mode is selected by the mode selector 140, the battery 170 may be connected to a power terminal VDD of the sensor unit 130 to supply power to the sensor unit 130. The battery 170 may comprise a disposable primary battery and a chargeable secondary battery.

The Bluetooth communication unit 150 may transmit and receive a control signal and a voice signal to and from a Bluetooth-enabled specific terminal. For example, when an inquiry signal is received under the control of the controller 110, the Bluetooth communication unit 150 may receive an inquiry response signal with respect to the inquiry signal from the specific terminal. When an identification information request signal is received from the specific terminal, the Bluetooth communication unit 150 may transmit a Bluetooth address BD_ADDR as a unique address, a class of device, a page scan repetition mode, a page scan mode, a clock offset, and a model name to the specific terminal under the control of the controller 110. The Bluetooth communication unit 150 may receive a pairing request signal transmitted from the specific terminal. In this particular case, the Bluetooth communication unit 150 may receive a pin code required for authentication from the specific terminal. Especially, when a Bluetooth communication channel with the specific terminal is established but the sensor unit 130 is inactive, the Bluetooth communication unit 150 may transmit a message informing that the Bluetooth communication channel is disconnected to the specific terminal under the control of the controller 110.

The storage unit 120 stores programs to drive the Bluetooth headset 100 and data generated when the programs are used. For example, the storage unit 120 stores a unique pin code of the Bluetooth headset 100. The storage unit 120 may store the Bluetooth address BD_ADDR as the unique address, a class of a slave device, the page scan repetition mode, the page scan mode, the clock offset, and the model name. Especially when the Bluetooth headset 100 is turned on by the sensor unit 130, the storage unit 120 may store information about a specific terminal, such as a user mobile terminal, which automatically establishes a Bluetooth communication channel.

The mode selector 140 is a device for selecting an operating mode of the Bluetooth headset 100. The operating mode of the Bluetooth headset 100 may include a power-off mode, a power-on mode, and a sensor mode. The power-off mode indicates a mode when power to the Bluetooth headset 100 is cut off, the power-on mode indicates a mode when power is supplied to elements of the Bluetooth headset 100, and the sensor mode indicates a mode when a power-on/off of the Bluetooth headset 100 are automatically controlled by the sensor unit 130.

The mode selector 140 may include an input terminal IN to which the battery 170 is connected, an off-terminal OFF connected to the input terminal IN in the power-off mode, an on-terminal ON connected to the input terminal IN in the power-on mode, and a sensor terminal S connected to the input terminal IN in the sensor mode.

More particularly with reference to FIG. 1, the input terminal IN may be connected according to a selected one of the three modes via the mode selector 140. For example, the mode selector 140 may connect the input terminal IN to the off-terminal OFF to cut the power to the Bluetooth headset 100 off in the power-off mode, and may connect the input terminal IN to the on-terminal ON to supply the power to the Bluetooth headset 100 in the power-on mode. In the sensor mode, the mode selector 140 may connect the input terminal IN to the sensor terminal S to supply the power of the battery 170 to the power terminal VDD of the sensor unit 130 such that the sensor unit 130 can sense the state information of the Bluetooth headset 100.

The sensor unit 130 comprises a device for sensing the status information of the Bluetooth headset 100, for example, whether the Bluetooth headset 100 is currently worn by a user and may receive the power through the power terminal VDD from the battery 170 when the operating mode of the Bluetooth headset 100 is set to the sensor mode by the mode selector 140. The sensor unit 130 may include at least one of a temperature sensor, an optical sensor, a touch sensor, and a tilt sensor. It is also possible to utilize a biometric sensor to detect pulse, skin resistance, or many other kinds of biological characteristics to determine that the headset is being worn.

When the sensor unit 130 is a temperature sensor and the temperature sensor senses temperature equal to or higher 30 degrees Centigrade and less than 39 degrees Centigrade, similar to human body temperature, the sensor unit 130 may determine that a user is currently wearing the Bluetooth headset 100 and may output a first signal turning on the Bluetooth headset 100 through an output terminal OUT of the sensor unit 130. In this case, the first signal may be transmitted to the booting terminal BOOT of the controller 110. When the sensor unit 130 includes an optical sensor and light having intensity lower than a preset value is received by the optical sensor, the sensor unit 130 may determine the user is wearing the Bluetooth headset 100, and may output the first signal through the output terminal OUT of the sensor unit 130. In this case, the optical sensor may be mounted at a position so that light is blocked when the Bluetooth headset 100 is being worn. When the sensor unit 130 includes a touch sensor and a touch is sensed by the touch sensor for a preset time, the sensor unit 130 may determine the user wears the Bluetooth headset 100 and may output the first signal through the output terminal OUT of the sensor unit 130. In this case, the touch sensor may be a capacitive touch sensor in order to prevent malfunction caused by a touch of a book, a wallet, etc., in a bag. When the sensor unit 130 includes a tilt sensor and a tilt value is sensed that corresponds to a tilt value when the Bluetooth headset 100 is being worn, the sensor unit 130 may output the first signal through the output terminal OUT of the sensor unit 130.

Meanwhile, when the sensor unit 130 includes only one of the above-mentioned sensors, the state information of the Bluetooth headset 100 is possibly erroneously sensed. For example, when the sensor unit 130 includes only the temperature sensor and when the user holds the Bluetooth headset 100 while touching the temperature sensor in a state where the Bluetooth headset 100 is set to the sensor mode, the sensor unit 130 may output the first signal erroneously. In this case, the Bluetooth headset 100 is turned on. When the sensor unit 130 includes only the optical sensor and the Bluetooth headset 100 is placed in a bag in a state where the Bluetooth headset 100 is set to the sensor mode, since the optical sensor senses light lower than a preset value, the sensor unit 130 may output the first signal. Thus, in order to prevent these malfunctions, the sensor unit 130 may include at least two of the above-mentioned sensors. In this case, the sensor unit 130 may output the first signal when the two sensors both sense the Bluetooth headset 100 is being worn and may output a second signal turning off the Bluetooth headset 100 when any one of the two sensor senses the Bluetooth headset 100 is not being worn. Hereinbefore, the sensor unit 130 senses whether the Bluetooth headset 100 is worn using two sensors, but the present invention is not limited thereto. For example, when the sensor unit 130 includes at least three sensors and the three sensors all sense the Bluetooth headset 100 is being worn, the sensor unit 130 may be activated to output the first signal. In addition, when the sensor unit 130 includes a plurality of sensors (for example, at least three sensors) and the number of sensors equal to or greater than a preset number (for example, two) sense the Bluetooth headset 100 is being worn, the sensor unit 130 may be activated to output the first signal.

The controller 110 controls overall operation of the respective elements of the Bluetooth headset 100. For example, the controller may control the establishment of the Bluetooth communication channel of the Bluetooth headset 100. Especially, when the operating mode of the Bluetooth headset 100 is set to the sensor mode by the mode selector 140, the controller 110 may control power ON/OFF of the Bluetooth headset 100 according to the output signal received from the sensor unit 130. In other words, when the sensor unit 130 is activated and the first signal is input through the booting terminal BOOT, the controller 110 may turn the Bluetooth headset 100 on. Here, the first signal is output from the output terminal OUT of the sensor unit 130 when the Bluetooth headset 100 is set to the sensor mode and at least one of the sensors of the sensor unit 130 senses the Bluetooth headset 100 is worn. When the Bluetooth headset 100 is powered on, the controller 110 may control the Bluetooth communication channel to be automatically established between the Bluetooth headset 100 and additionally a preset specific terminal. By doing so, when the Bluetooth headset 100 is set to the sensor mode, the Bluetooth communication channel between the specific terminal the Bluetooth headset 100 is automatically established only by wearing the Bluetooth headset 100 on ears so that user convenience can be improved.

Meanwhile, when the sensor unit 130 is deactivated and the second signal is input to the booting terminal BOOT of the controller 110, the controller 110 may turn the Bluetooth headset 100 off. In this particular case, when the Bluetooth headset 100 establishes a wireless communication channel with a specific terminal, the controller 110 may transmit a message informing of disconnection of the wireless communication channel to the specific terminal and may turn the Bluetooth headset 100 off. Here, the second signal is output from the output terminal OUT of the sensor unit 130 when the Bluetooth headset 100 is set to the sensor mode and at least one of the sensors of the sensor unit 130 senses the Bluetooth headset 100 is not worn.

In the Bluetooth headset 100 according to the exemplary embodiment of the present invention, the mode selector 140 sets a mode of the Bluetooth headset 100 to the sensor mode such that the Bluetooth headset 100 is automatically turned off to prevent the battery from being consumed when the Bluetooth headset 100 is not being used, typically by determining whether the Bluetooth headset 100 is being worn. Moreover, since the Bluetooth headset 100 is automatically turned on/off, user convenience can be improved.

Hereinafter, a method of controlling power of the Bluetooth headset 100 according to an exemplary embodiment of the present invention will be described.

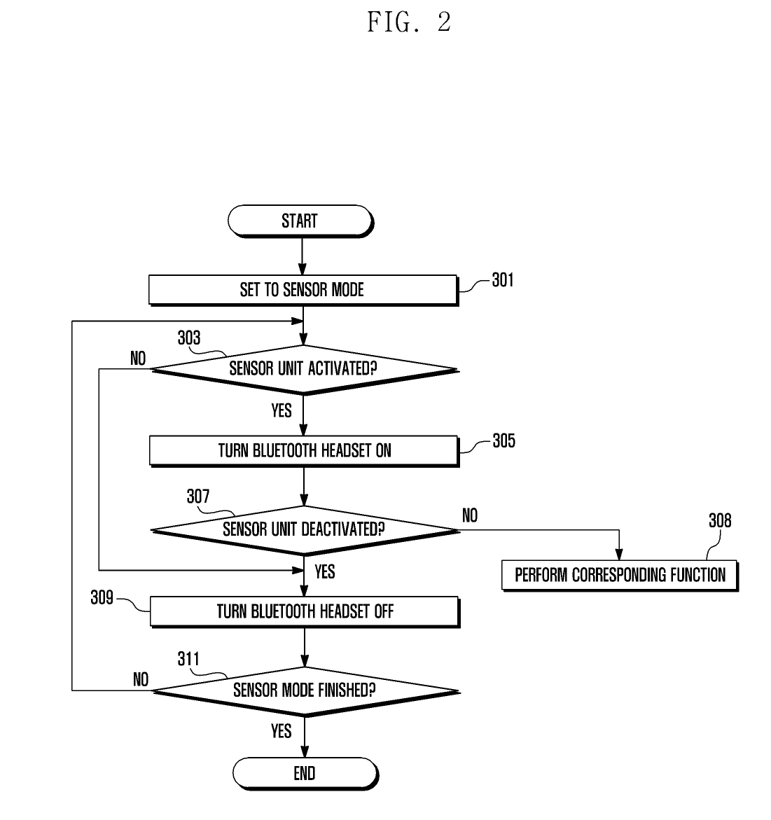

FIG. 2 is a flowchart illustrating a power controlling method of a Bluetooth headset according to an exemplary embodiment of the present invention.

Referring now to FIGS. 1 and 2, at step (301), the Bluetooth headset 100 may be set to the sensor mode. In the sensor mode, the sensor unit 130 may receive power through the power terminal VDD from the battery 170. The sensor unit 130 may include at least one of a temperature sensor, an optical sensor, a touch sensor, and a tilt sensor, just to name a few possibilities.

At step (303), the Bluetooth headset 100 may check whether the sensor unit 130 is activated. The sensor unit 130 may be activated when at least one of the sensors included in the sensor unit 130 senses the Bluetooth headset 100 is worn. In this particular case, the sensor unit 130 may transmit the first signal to the booting terminal BOOT of the controller 110 through the output terminal OUT.

When the sensor unit 130 is activated at step (303), then at step (305) the controller 110 may turn the Bluetooth headset 100 on. That is, the controller 110 may perform a booting process when the first signal is input to the booting terminal BOOT. When the sensor unit 130 is not activated, that is, when the sensor included in the sensor unit 130 senses the Bluetooth headset 100 is not being worn, the sensor unit 130 may output the second signal through the output terminal OUT. In this particular case, the Bluetooth headset 100 may maintain the power-off state if already turned off. Alternatively, at step (309), the Bluetooth headset 100 may be turned off when a previous state is a power-on state.

Meanwhile, although not depicted in FIG. 2, the controller 110 may establish a Bluetooth communication channel between the Bluetooth headset 100 and a preset specific terminal when the booting is completed. In this case, the Bluetooth communication function of the specific terminal must be activated.

When the Bluetooth communication channel between the Bluetooth headset 100 and the specific terminal is established, the controller 110 may transmit and receive a signal checking the Bluetooth communication channel to and from the specific terminal through the Bluetooth communication unit 150 for a preset period. The Bluetooth headset 100 may receive a music file reproducing signal or a voice call signal from the specific terminal to reproduce the received signal through the speaker SPK of the audio processor 160. Here, since the establishment of the Bluetooth communication channel between the Bluetooth headset 100 and the specific terminal is known well to those skilled in the art, its description will be omitted.

Referring again to the flowchart in FIG. 2, at step (307) the controller 110 may check whether or not the sensor unit 130 is deactivated. When the sensor included in the sensor unit 130 senses the Bluetooth headset 100 is not being worn, the sensor unit 130 may be deactivated. In this case, the sensor unit 130 may transmit the second signal to the booting terminal BOOT of the controller 110 through the output terminal OUT.

At step (307), when it is determined that the sensor unit 130 is not deactivated, then at step (308) the controller 110 may perform a corresponding function. For example, the controller 110 may perform reproduction of a music file or a voice call, or set the Bluetooth headset 100 to a standby mode.

However, at step (307) when the sensor unit 130 is deactivated, then at step (309) the controller 110 may turn the Bluetooth headset 100 off. In this particular case, when the Bluetooth communication channel is established between the specific terminal and the Bluetooth headset 100, the controller 110 may transmit a message informing disconnection of the Bluetooth communication channel to the specific terminal and may turn the Bluetooth headset 100 off.

At step (311), the Bluetooth headset 100 may check the sensor mode is finished. The sensor mode may be finished when a mode of the Bluetooth headset 100 is switched to the power-off mode or the power-on mode by the mode selector 140. If the sensor mode is not finished, the Bluetooth headset 100 may return to step (303) and the above-mentioned processes may be repeated. On the contrary, when the sensor mode is finished, the Bluetooth headset 100 may be operated in the power-off mode or the power-on mode selected by the mode selector 140.

Meanwhile, in order to sense more precisely whether or not the Bluetooth headset 100 is being worn, the sensor unit 130 may include at least two of the above-mentioned sensors. In this case, the sensor unit 130 may output the first signal when the two sensors all sense the Bluetooth headset 100 is worn and may output the second signal when any one of the sensors senses the Bluetooth headset 100 is not worn. Alternatively, the sensor unit 130 may include a plurality of sensors (for example, more than three sensors) and may be activated when the number of sensors equal to or higher a preset number (for example, two) sense the Bluetooth headset 100 is worn. Finally, as previously discussed herein above, a biometric sensor could be used in addition to or in lieu of the types of sensors mentioned above.

Hereinbefore, the status information of the Bluetooth headset 100 (as to whether or not the Bluetooth headset is worn) is precisely sensed using a plurality of sensors, but the present invention is not limited thereto. For example, in the present invention, when any one (hereinafter, referred to as a ‘first sensor’) of sensors included in the sensor unit 130 senses the Bluetooth headset 100 is worn, a second sensor distinguished from the first sensor is driven to check the state information of the Bluetooth headset 100 again such that it is possible to check whether the state information sensed by the first sensor is correct, i.e. its output is accurate.

According to the present invention, at least one sensor senses whether or not the Bluetooth headset is being worn and the Bluetooth headset is turned on only when it is determined that the Bluetooth headset is being worn so that undesired consumption of the battery power can be prevented. Since a plurality of sensors is used, erroneous sensing on the status information of the Bluetooth headset can be remarkably reduced in comparison to the case when a single sensor is used.

Although exemplary embodiments of a method of and an apparatus for controlling power of a Bluetooth headset according to the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims. For example, although Bluetooth is the preferred protocol, a person of ordinary skill in the art understands and appreciates that the claimed invention is not strictly limited to Bluetooth, and other protocols, such as Zigbee and ultra wide band (UWB). Furthermore, while the term “headset” is used, a person of ordinary skill in the art understands and appreciates that a single insertable ear pierce or an externally positioned speaker, ear bus(s) are just a few of the devices that can be considered headsets. The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

What is claimed is:

1. A method of controlling a power status of a Bluetooth headset, comprising:
setting a mode of the Bluetooth headset to a sensor mode;
sensing whether or not the Bluetooth headset is worn by a user; and
automatically turning the Bluetooth headset on or off according to the sensing as to whether or not the Bluetooth headset is being worn.

2. The method of claim 1, wherein the Bluetooth headset is turned on or remains powered on when a sensor senses that the Bluetooth headset is being worn by a user.

3. The method of claim 1, wherein the Bluetooth headset is turned off or remains powered off when a sensor senses that the Bluetooth headset is not being worn by a user.

4. The method of claim 1, wherein the sensing comprises:
sensing by any one of an optical sensor, a touch sensor, a temperature sensor, a biometric sensor, and a tilt sensor that the Bluetooth headset is being worn; and
driving another sensor distinguished from the any one sensor to check again whether the Bluetooth headset is worn.

5. The method of claim 1, wherein the sensing comprises sensing whether or not the Bluetooth headset is being worn by using at least two of an optical sensor, a touch sensor, a temperature sensor, a biometric sensor, and a tilt sensor.

6. The method of claim 5, wherein the automatically turning the Bluetooth headset on/off comprises:
turning the Bluetooth headset on when at least two of the sensors sense the Bluetooth headset is being worn; and
turning the Bluetooth headset off when at least one of the at least two sensors senses the Bluetooth headset is not being worn.

7. The method of claim 1, further comprising automatically establishing a Bluetooth communication channel between the Bluetooth headset and a preset specific terminal after the Bluetooth headset is turned on.

8. The method of claim 7, further comprising:
transmitting a message informing of a disconnection of the Bluetooth communication channel to the specific terminal when the Bluetooth communication channel is established between the specific terminal and the Bluetooth headset and the Bluetooth headset is being not worn; and
turning the Bluetooth headset off.

9. An apparatus for controlling a power status of a Bluetooth headset comprising:
a sensor unit including at least one sensor for sensing whether the Bluetooth headset is being worn by a user; and
a controller controlling a power on or off of the Bluetooth headset according to an output signal from the sensor unit corresponding to whether the Bluetooth headset is being worn.

10. The apparatus of claim 9, further comprising a mode selector for selecting one of a power-on mode, a power-off mode, and a sensor mode.

11. The apparatus of claim 9, wherein the controller powers on or keeps powered on the Bluetooth headset when a sensor senses that the Bluetooth headset is being worn by a user.

12. The apparatus of claim 9, wherein the controller powers off or keeps powered off the Bluetooth headset when a sensor senses that the Bluetooth headset is not being worn by a user.

13. The apparatus of claim 9, wherein the sensor unit comprises at least two of an optical sensor, a temperature sensor, a touch sensor, and a tilt sensor, and wherein
another sensor distinguished from any one of the sensors is driven to check again whether the Bluetooth headset is worn when the any one sensor senses the Bluetooth headset is worn.

14. The apparatus of claim 9, wherein the sensor unit comprises at least two of an optical sensor, a temperature sensor, a touch sensor, and a tilt sensor, wherein
a first signal turning the Bluetooth headset on is output when the at least two sensors all sense the Bluetooth headset is being worn and a second signal turning the Bluetooth headset off is output when at least one of the at least two sensors senses the Bluetooth headset is not being worn.

15. The apparatus of claim 9, wherein the controller automatically establishes a Bluetooth communication channel between a preset specific terminal and the Bluetooth headset when the Bluetooth headset is turned on by the sensor unit.

16. The apparatus of claim 15, wherein, when the Bluetooth communication channel is established between the specific terminal and the Bluetooth headset and it is sensed that the Bluetooth headset is not being worn, the controller transmits a message informing of a disconnection of the Bluetooth communication channel to the specific terminal and turns the Bluetooth headset off.

17. The apparatus of claim 9, wherein the sensing unit includes a biometric sensor for sensing whether the Bluetooth headset is being worn.
